(19) United States
(12) Patent Application Publication
(10) Pub. No.: US 2025/0341383 A1
(43) Pub. Date: Nov. 6, 2025

(54) WEAPON-MOUNTED CAMERA SYSTEM WITH INTEGRATED HELMET DISPLAY

(71) Applicant: Maxwell Holt, Frederick, CO (US)

(72) Inventor: Maxwell Holt, Frederick, CO (US)

(73) Assignee: Maxwell Holt, Frederick, CO (US)

(21) Appl. No.: 19/172,735

(22) Filed: Apr. 8, 2025

Related U.S. Application Data
(63) Continuation of application No. PCT/US2024/049849, filed on Oct. 3, 2024.
(60) Provisional application No. 63/542,823, filed on Oct. 6, 2023.

(51) Int. Cl. F41G 1/473; A42B 3/04; G02B 27/01; H04N 23/23; H04N 23/51; H04N 23/65

(52) U.S. Cl. CPC F41G 1/473; A42B 3/042; G02B 27/0176; H04N 23/23; H04N 23/51; H04N 23/65

(57) ABSTRACT

The invention comprises a weapon-mounted camera system with a low-profile frontal enclosure attachable to a weapon's Picatinny rail, containing a high-resolution camera and wireless transmitter. A helmet-mounted display system includes a rear enclosure with a receiver and power supply, connected via cable to a front enclosure with a high-resolution display. The system allows real-time image transmission from the weapon to the helmet display, enhancing situational awareness without obstructing existing sights. It features efficient power management, modular design, and compatibility with various weapon configurations, offering advantages over prior art in interchangeability, durability, and non-interference with primary optical systems.

### CROSS REFERENCE TO RELATED APPLICATIONS

This application claims the benefit of U.S. Provisional Patent Application 63/542,823 filed on Oct. 6, 2023, and PCT Patent Application PCT/US24/49849 filed on Oct. 3, 2024, each of which is hereby incorporated by reference in its entirety.

### BACKGROUND OF THE INVENTION

When firing around a corner, a signal transmitted wirelessly from a module located near the front of a gun may encounter interference upon transmission to a helmet-mounted apparatus. In the context of a high-stress, high-consequence combat situation, any imperfection or delay in the transmission of images, video or other information as collected by a module located near the front of a weapon to a helmet-mounted module could mean the difference between life and death.

Especially in combat situations, a cabled system linking a module located on or near the front aspect of a weapon to a module affixed to the helmet of a person holding the weapon may undesirably tangle. In some situations, the wire or cable running from or near the frontal aspect of a weapon to the helmet may catch or snag on other options. In such situations, the cable or wire may disconnect from either the module near the front of the weapon or a module linked to the helmet, or otherwise impede the movement of the holder of the weapon.

Existing weapon-mounted camera systems, such as those described in the prior art, present several limitations that the present invention aims to address. For instance, the BAE Systems Enhanced Night Vision Goggle III/Family of Weapon Sight-Individual (ENVG III/FWS-I) system, while providing integrated situational awareness and thermal targeting capabilities, lacks interchangeability and versatility. Systems similar to this example are designed to work exclusively with other sights of its kind, limiting its compatibility with various weapon configurations commonly used by soldiers. It therefore remains desirable to provide weapon-mounted camera systems that preserve compatibility with other components.

Moreover, prior art systems like the ENVG III/FWS-I often obstruct the weapon's existing scope picture, interfering with the soldier's ability to use previously installed gunsights such as ACOG, EOTech, or other reflex sights. As such, it remains desirable to provide a lower profile design that can complement, rather than replace, existing optical systems following installation.

Another significant drawback of many night vision scopes is their reliance on phosphorous tubes. These components have a limited lifespan and require frequent replacement, leading to increased maintenance costs and potential downtime in critical situations.

It remains an unsolved problem to develop a more optimal system to facilitate the capture of images, video and other information downrange from a gun while avoiding signal degradation when objects may be placed between the straight-line trajectory from the frontal aspect of a gun to the helmet of a person holding the gun. It remains an unsolved problem to develop a more optimal system to facilitate the capture of images, video and other information with a cable while minimizing the risk of the cable disconnecting or catching objects in a way that may impede the movement of the holder of a weapon.

### SUMMARY

The instant invention comprises a system adapted to be coupled to a weapon, and in the preferred embodiment a Gun, and a Helmet, for capturing photographic or video images through a Camera located near the frontal aspect of a Gun incorporated within a Frontal Enclosure, for presentation upon a helmet-mounted Display incorporated within a Front Helmet Enclosure. The system in the preferred embodiment further comprises a Rear Helmet Enclosure comprising a battery power supply and receiving antenna and connected by cable to the Front Helmet Enclosure.

Accordingly, a basic object of this invention is to photographically capture images or video from a Camera incorporated within a Frontal Enclosure for presentation upon a Display as an aspect of a Front Helmet Enclosure mounted to the Helmet of a person holding a weapon to which the system is attached.

Another fundamental object is to provide an accessory for transmitting images through wired or wireless connection to allow for minimization of latency or signal termination during combat situations or other situations where objects may interfere with the signals originating from aspects of the Frontal Enclosure destined for aspects of the Front Helmet Enclosure.

Another basic object is to mount a Camera on a weapon and capture telescopic scope images without interfering with the use of the firearm or the accuracy of the scope.

Another basic object is to enable the affixation of a Display communicatively connected to a Camera mounted on a weapon to present images and video to the holder of the weapon without interfering with the use of the firearm or the accuracy of the scope.

A related object is to provide a quick-connect and quick disconnect Camera accessory for a weapon that enables Camera images to be captured, without interfering with the access or visibility of aiming mechanisms unrelated to the Camera. A related object of the present invention to enable pictures and video to be taken through an attached Camera without blocking or interfering with the normal view of the person holding the weapon.

### BRIEF DESCRIPTION OF THE FIGURES

FIG. 1 depicts an embodiment of the frontal enclosure attached to a weapon via a Picatinny rail system.

FIG. 2a illustrates a perspective view of an embodiment of the front helmet enclosure.

FIG. 2b shows an embodiment of the front helmet enclosure attached to a helmet.

FIG. 2c presents another perspective view of an embodiment of the front helmet enclosure.

FIG. 2d illustrates an embodiment of the front helmet enclosure with the display visible, attached to a helmet.

FIG. 3 depicts a lower perspective view of an embodiment of the front helmet enclosure.

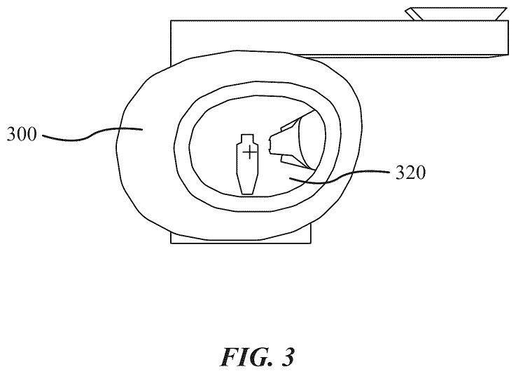

FIG. 4 shows an embodiment of the rear helmet enclosure and front helmet enclosure attached to a helmet.

FIG. 5 illustrates an embodiment of the rear helmet enclosure.

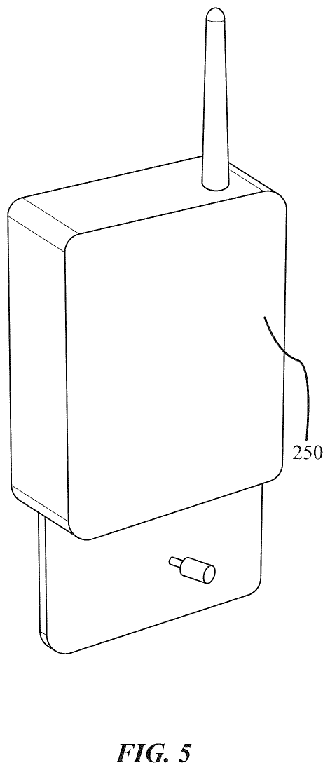

FIG. 6 depicts a detailed view of an embodiment of the display.

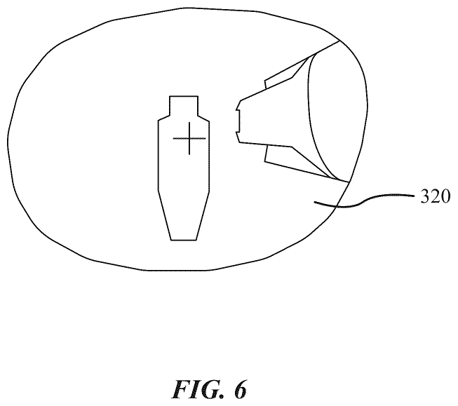

FIG. 7 shows an exploded view of an embodiment of the frontal enclosure, highlighting its attachment to a Picatinny rail system.

FIG. 8 illustrates an embodiment of the frontal enclosure attached to a weapon's Picatinny rail system.

FIG. 9 depicts a perspective view of an embodiment of the frontal enclosure.

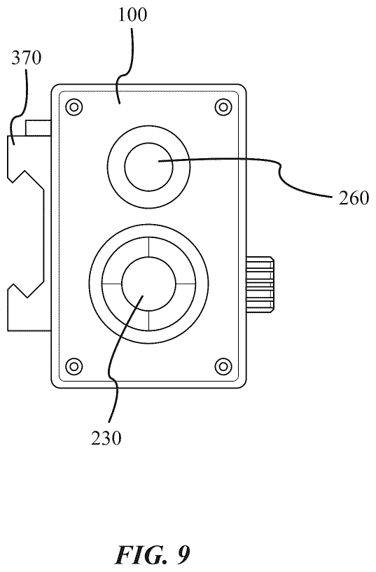

FIG. 10 shows another perspective view of an embodiment of the frontal enclosure, highlighting its components.

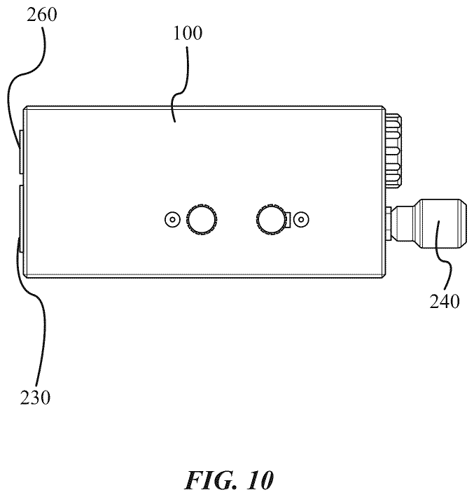

FIG. 11a is a perspective view showing the frontal enclosure and the helmet-mounted display system components positioned relative to the weapon system in accordance with an exemplary embodiment.

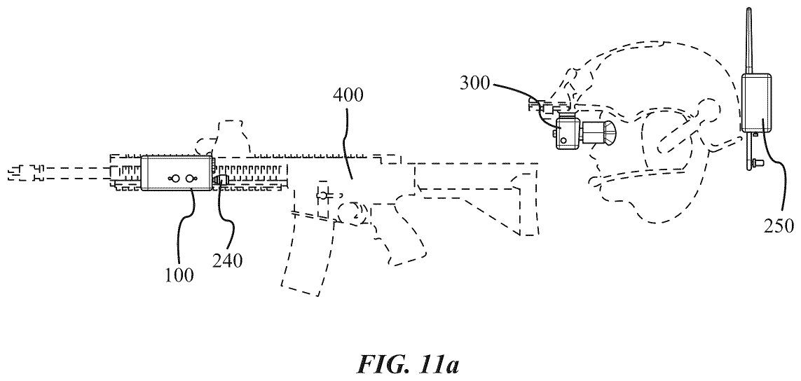

FIG. 11b is an alternative perspective view of the frontal enclosure and weapon-mounted configuration showing an exemplary spatial relationship between the camera system components and the weapon platform in accordance with an embodiment.

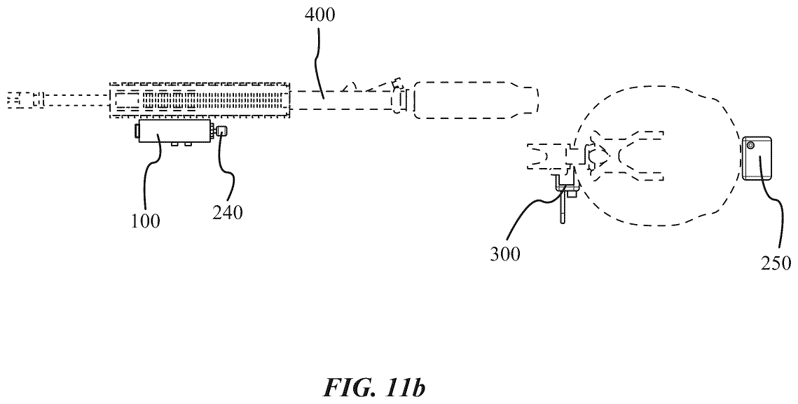

### DETAILED DESCRIPTION

The preferred embodiment of the invention comprises a design featuring a low-profile Frontal Enclosure 100 that houses a Camera 260, which provides a versatile, non-obstructive solution that can be easily integrated with existing weapon configurations. This approach allows soldiers to maintain their preferred optical sights while gaining the additional benefits of a weapon-mounted camera system, enhancing situational awareness and operational effectiveness without compromising the functionality of their primary aiming devices.

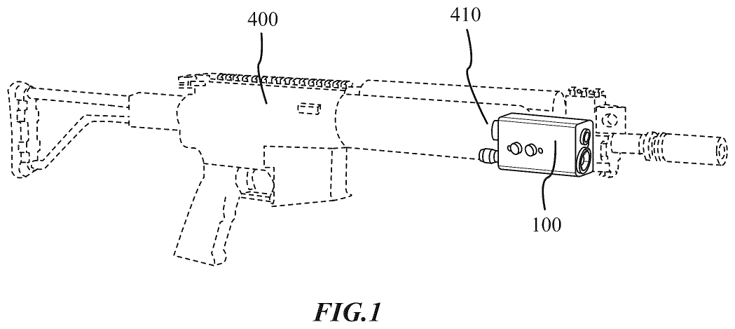

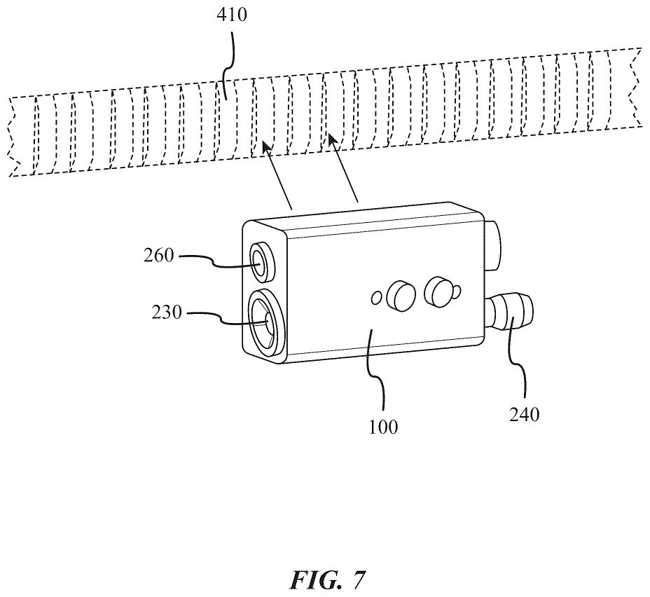

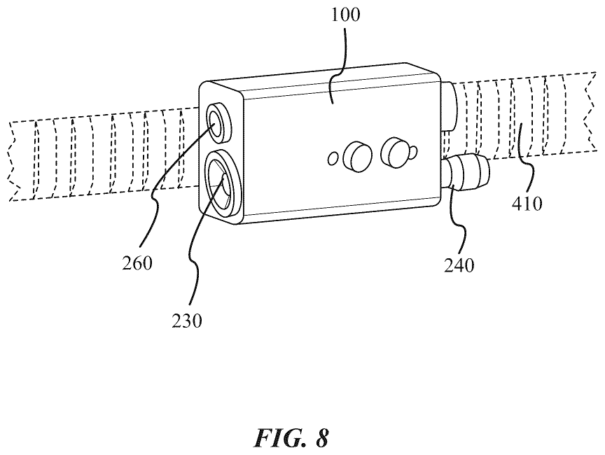

The preferred embodiment comprises a Frontal Enclosure 100. In the intended method of use, the Frontal Enclosure 100 attaches to the frontal aspect of a Gun 400, as depicted in FIG. 1. In an embodiment, the Frontal Enclosure 100 further comprises a means to attach to the frontal aspect of a Picatinny Rail System 410 located nearest to the barrel of the Gun 400. In the preferred embodiment, the Frontal Enclosure 100 comprises a Picatinny Rail attachment, whereby the Frontal Enclosure 100 may be secured to a Gun 400 via a Picatinny Rail System 410, as depicted in FIGS. 7 and 8. In various embodiments, the Frontal Enclosure 100 attachably links to the frontal aspect of the Gun 400 with any mechanism that allows for the alignment of the Camera 260 with the trajectory indicated by the Gun 400. The present inventor has recognized that a Picatinny Rail System 410 allows for the alignment of attachments to points downrange of the Gun 400. It is an aspect of the invention to provide for the alignment of the direction of the Camera 260 down range of the weapon, such that a view down range of the weapon can be presented upon a Display 320 in association with accurate reticle in an embodiment. In an embodiment, the Frontal Enclosure 100 further incorporates buttons or dials to allow for calibration of the zoom, alignment, aiming, Camera 260 position, or other user controllable elements, optionally in association with an interface presented upon a Display 320. In the preferred embodiment, the Frontal Enclosure 100 accomplishes detachable mounting to the front aspect of a Gun 400.

In an embodiment, the Frontal Enclosure 100 is configured to quickly and easily attach to a Gun 400 without modification, disfigurement, or damage to the existing Gun 400. Although the mounting 370 of the Frontal Enclosure 100 provides acceptable alignment for photography or videography purposes in association with the included Camera 260, it is also envisioned in embodiments to obtain more accurate alignment in association with reticle training via mechanisms as known in the art. In accordance with embodiments, the Frontal Enclosure 100 is of rugged construction which is needed for military applications and allows quick and easy attachment and detachment.

The Frontal Enclosure 100 comprises a Camera 260 in the preferred embodiment. In various embodiments, directional path protruding directly from the most distal point of the lens of the Camera 260 is oriented along the Gun 400 such that the line of view is parallel to the firing trajectory of the Gun 400. In the intended method of use, the Frontal Enclosure 100 is placed upon the Gun 400 such that the Camera 260 captures images down range along the firing trajectory of the Gun 400. In various embodiments, the Frontal Enclosure 100 is placed on the top, either of the sides, or the bottom of the Gun 400 with the Camera 260 pointing forward.

The Camera 260, housed within the Frontal Enclosure, utilizes a high-resolution sensor with at least 1000 lines of resolution in accordance with the preferred embodiment. This high resolution is crucial for capturing clear, detailed images in various combat scenarios. The specific camera model selected in accordance with the preferred embodiment, the Readytosky Mini 1000TVL FPV Camera, meets and exceeds this requirement with its 1000 TV lines resolution capability.

In terms of field of view, the Camera 260 is designed to provide a wide-angle perspective of at least 90 degrees. This wide field of view is essential for capturing a broad area in front of the weapon, enhancing situational awareness for the user. The selected camera model surpasses this requirement, offering a 110-degree field of view, which allows for an even wider coverage area. This expanded field of view enables users to observe a larger portion of their surroundings without the need to significantly adjust their weapon position.

For the Display 320 integrated into the Helmet Enclosure 300, the resolution specification is set to meet or exceed PAL video resolution. PAL (Phase Alternating Line) standard typically offers a resolution of 720×576 pixels. The chosen display component, a 0.39 Inch Viewfinder Display Module, significantly exceeds this requirement with its 1024×768 pixel resolution. This high-resolution display ensures that the user can view clear, detailed images transmitted from the Camera 260, even when the Display 320 is positioned close to the eye (less than 2 inches) as specified in the design requirements.

The combination of high camera resolution and wide field of view, coupled with a high-resolution display, enables the system to provide users with detailed, expansive visual information. This is particularly important in the intended use case of the invention, where users need to quickly and accurately assess their surroundings in high-stress combat situations. The high-resolution imagery allows for better identification of potential threats or objects of interest, while the wide field of view provides enhanced situational awareness.

Furthermore, these specifications work in conjunction with other components of the system in accordance with the preferred embodiment, such as the wireless transmission setup, to ensure that the high-quality video feed from the Camera 260 is effectively transmitted and displayed on the Display 320 with minimal latency or signal degradation. This enables the user to receive real-time, high-quality visual information, which is crucial for making quick decisions in combat scenarios.

In an embodiment of the invention, the Frontal Enclosure 100 further comprises a Rangefinder Laser. The Rangefinder Laser may be of any configuration capable of collecting distance information to an object or location downrange from the Gun 400, and communicating the distance information for presentation upon a Display 320. The Rangefinder Laser is oriented within the Frontal Enclosure 100 to point where the nozzle is aimed downrange in accordance with a Rangefinder Laser.

The Camera 260 in the Frontal Enclosure 100 in an exemplary embodiment comprises a Readytosky Mini 1000TVL FPV Camera. This camera configuration is a ⅓ CCD sensor with a 2.8 mm lens, providing a wide 110-degree field of view. The camera in such configuration operates on a voltage range of 5V-20V, making it compatible with the power supply system of the invention in an embodiment. Its high resolution of 1000 TV lines ensures clear and detailed image capture, which is crucial for the system's effectiveness in providing accurate visual information to the user.

In an alternative embodiment of the invention, the Frontal Enclosure 100 further comprises a second camera in the form of a thermal camera. This thermal camera in such embodiment is integrated alongside the existing Camera 260 to provide enhanced imaging capabilities in various environmental conditions.

The thermal camera module utilized in an exemplary embodiment is based on the HM-TM5X-XRG/C series, which supports both UART serial communication and CVBS video communication protocols. This thermal camera is capable of capturing high-resolution thermal images with at least 1000 lines of resolution and a field of view of at least 90 degrees.

The thermal camera module can be configured to communicate with the existing systems of the Frontal Enclosure 100 through a UART serial interface. This allows for seamless integration with the current image processing and transmission capabilities of embodiments of the invention. The thermal images captured by this camera can be transmitted wirelessly to the Rear Helmet Enclosure 200 using the existing AKK X2-Ultimate 5.8 GHz transmitter. The thermal camera module in an embodiment supports various adjustable parameters that can be controlled via serial commands, including brightness, contrast, image detail digital enhancement, and palette settings. These features allow for optimized thermal imaging in different combat scenarios in accordance with intended uses of an embodiment of an invention

Integration of the thermal camera module enhances the system's capabilities in an embodiment by providing thermal imaging alongside the standard visual imaging. This dual-camera setup in the Frontal Enclosure 100 offers users the ability to switch between visual and thermal views or overlay them, optionally via the dials incorporated into the Front Helmet Enclosure, significantly improving situational awareness in low-light conditions or when detecting heat signatures is crucial.

The thermal camera's output in an embodiment displayed on the existing Display 320 in the Front Helmet Enclosure 300, utilizing the same power and signal transmission systems in place for the Camera 260. This ensures that the addition of thermal imaging capabilities does not significantly alter the overall design and usability of the system in embodiments incorporating the thermal camera.

The preferred embodiment of the invention incorporates specifically configured Helmet Enclosures, divided into two main components: the Rear Helmet Enclosure 200 and the Front Helmet Enclosure 300. This design ensures optimal functionality and user comfort while maintaining the system's effectiveness in combat situations. In accordance with various embodiments, the Helmet Enclosures are affixed to or otherwise retained upon aspects of a helmet in accordance with various means as easily apparent to those skilled in the art.

The Rear Helmet Enclosure 200 is designed for placement on the rear aspect of the helmet 500, providing a strategic location for signal reception and power management. It houses several critical components, including a receiver 250, optionally the AKK RC832 receiver, which is specifically designed to work in conjunction with the AKK X2-Ultimate transmitter in the Frontal Enclosure 100. It also contains a battery enclosure 270, optionally comprising a battery pack utilizing CR123 disposable batteries, serving as the primary power source for both the receiver 250 and the Display 320 in the Front Helmet Enclosure 300. Additionally, it incorporates a DC-DC boost converter that steps up the battery voltage (4V to 6V range) to 12V, necessary for powering the receiver 250 and other components.

The Front Helmet Enclosure 300 is positioned to allow the user easy access to the Display 320 in an embodiment. It contains the Display 320, which is a 0.39 Inch Viewfinder Display Module with a high resolution of 1024×768 pixels. It also features a specialized video/power port designed to interface with the corresponding port on the Rear Helmet Enclosure.

The connection between the Rear Helmet Enclosure and the Front Helmet Enclosure 300 is facilitated by a specialized cable that efficiently transmits both power and video signals. This cable interfaces with the video/power ports on both enclosures, ensuring a streamlined and reliable connection. The cable carries regulated power supply from the battery enclosure 270 comprising a battery pack and optionally further comprising a battery cap 280 in the Rear Helmet Enclosure 200, converted to the appropriate voltage levels (3.5-5V) for the Display 320 in the Front Helmet Enclosure 300. It also transmits the video signal received by the AKK RC832 receiver 250 in the Rear Helmet Enclosure to the Display 320.

The cable connecting the two enclosures can be implemented using various suitable options designed for combined power and video signal transmission. Examples include a shielded multi-conductor cable like the Belden 1855A, which combines RG59 coaxial cable for video transmission with additional 18 AWG conductors for power delivery. Another option is a hybrid fiber optic cable such as the Canare FCFA series, which includes both optical fibers for high-quality video transmission and copper conductors for power delivery. For a more compact solution, a micro-coaxial cable like the Samtec UMCX series could be used, offering high-frequency signal transmission capabilities alongside power conductors in a small form factor.

This configuration of the Helmet Enclosures 300, with its separate Rear and Front components connected by a specialized cable, offers several advantages. It allows for optimal weight distribution on the helmet, enhancing user comfort during extended operations. It provides a clear separation between power management and display functions, potentially improving system reliability. The use of a single cable for both power and video signal transmission reduces potential points of failure and simplifies the overall system design.

By incorporating these design elements, the Helmet Enclosures configuration ensures efficient power management, reliable signal transmission, and optimal display positioning, all crucial factors for the system's effectiveness in high-stress combat situations.

The preferred embodiment of the invention incorporates a wireless transmission system to facilitate the transfer of video signals from the Frontal Enclosure 100 to the Rear Helmet Enclosure. In an embodiment, the Frontal Enclosure 100 comprises an AKK X2-Ultimate 5.8 GHz transmitter, which is responsible for sending the video feed captured by the Camera 260.

This transmitter in an embodiment operates on the 5.8 GHz frequency band, offering a balance between range and obstacle penetration. It features switchable power output levels ranging from 0.01 mW to 1000 mW, allowing for adjustable transmission range and power consumption based on operational needs. This flexibility is crucial for maintaining a stable video link in various combat scenarios.

The signal transmitted from the Frontal Enclosure 100 in an embodiment is received by a receiver 250, optionally an AKK RC832 receiver, which is contained within the Rear Helmet Enclosure. This receiver 250 is specifically designed to work in conjunction with the AKK X2-Ultimate transmitter, ensuring compatibility and optimal performance.

The Rear Helmet Enclosure is intended for placement on the rear aspect of the helmet, providing a strategic location for signal reception while maintaining a balanced weight distribution on the user's head. In accordance with the preferred embodiment, the Front Helmet Enclosure 300 is connected via wire to the Rear Helmet Enclosure 200, via a cable connecting these two components. This wired connection ensures a stable and interference-free transfer of the received video signal from the receiver 250 to the Display 320 located in the Front Helmet Enclosure 300.

The Display 320, housed within the Front Helmet Enclosure 300, is a 0.39 Inch Viewfinder Display Module with a high resolution of 1024×768 pixels. This compact display is positioned in such a way that the user can look through it, providing a clear view of the transmitted video feed from the Camera 260. The positioning of the display allows for seamless integration with the user's field of view, enabling them to maintain situational awareness while accessing the camera feed.

To enhance the wireless communication capabilities, the system incorporates a Readytosky Mini 5.8 G FPV Antenna with a 2.8 dBi gain and RHCP (Right Hand Circular Polarization) configuration. This antenna design provides a good balance between signal strength and physical durability, which is crucial for maintaining a stable connection in rugged operational environments.

The preferred embodiment of the invention thus incorporates a wireless transmission system 240 to facilitate the transfer of video signals from the Frontal Enclosure 100 to the Rear Helmet Enclosure 200. Specifically, the Frontal Enclosure 100 houses an AKK X2-Ultimate 5.8 GHz transmitter, which is responsible for sending the video feed captured by the Camera 260.

This transmitter operates on the 5.8 GHz frequency band, offering a good balance between range and obstacle penetration. It features switchable power output levels ranging from 0.01 mW to 1000 mW, allowing for adjustable transmission range and power consumption based on operational needs. This flexibility is crucial for maintaining a stable video link in various combat scenarios.

The signal transmitted from the Frontal Enclosure 100 is received by an AKK RC832 receiver 250, which is contained within the Rear Helmet Enclosure 200. This receiver 250 is specifically designed to work in conjunction with the AKK X2-Ultimate transmitter, ensuring compatibility and optimal performance. The AKK RC832 receiver 250 operates on a 12V power supply, which is provided by the DC-DC boost converter of the Helmet Enclosure 300.

To enhance the wireless communication capabilities, the system incorporates a Readytosky Mini 5.8 G FPV Antenna with a 2.8 dBi gain and RHCP (Right Hand Circular Polarization) configuration. This antenna design provides a good balance between signal strength and physical durability, which is crucial for maintaining a stable connection in rugged operational environments.

The wireless transmission system is designed to work in conjunction with other components of the system, such as the high-resolution Camera 260 and Display 320, to ensure that the high-quality video feed is effectively transmitted and displayed with minimal latency or signal degradation. This enables the user to receive real-time, high-quality visual information, which is crucial for making quick decisions in combat scenarios.

In the Rear Helmet Enclosure 200, an AKK RC832 receiver 250 is used to capture the transmitted video signal in an exemplary embodiment. This receiver 250 is designed to work in conjunction with the AKK X2-Ultimate transmitter, ensuring compatibility and optimal performance. The receiver 250 operates on a 12V power supply, which is provided by the DC-DC boost converter of the Helmet Enclosure 300 in an embodiment.

The preferred embodiment of the invention incorporates a wired connection system between the Front Helmet Enclosure 300 and the Rear Helmet Enclosure 200, ensuring reliable power and signal transmission. The Front Helmet Enclosure 300 features a specialized video/power port designed to interface with a corresponding port on the Rear Helmet Enclosure 200. This connection facilitates the transfer of both video signals and power through a single cable, streamlining the system's design and reducing potential points of failure.

The cable connecting the Rear Helmet Enclosure 200 to the Front Helmet Enclosure 300 is designed to efficiently transmit both power and video signals through a single, streamlined connection. This specialized cable interfaces with the video/power port on the Rear Helmet Enclosure 200 and a corresponding port on the Front Helmet Enclosure 300. The cable carries the regulated power supply from the battery pack in the Rear Helmet Enclosure 200, which has been converted to the appropriate voltage levels for the Display 320 (3.5-5V) in the Front Helmet Enclosure 300. Simultaneously, it transmits the video signal received by the AKK RC832 receiver 250 in the Rear Helmet Enclosure 200 to the Display 320. The cable connecting the Rear Helmet Enclosure 200 to the Front Helmet Enclosure 300 can be implemented using various suitable options designed for combined power and video signal transmission. One example is a shielded multi-conductor cable that incorporates both power and coaxial video lines within a single jacket. In an exemplary embodiment, the specific cable consists of the Belden 1855A, which combines RG59 coaxial cable for video transmission with additional 18 AWG conductors for power delivery. In an alternative embodiment, the cable consists of a hybrid fiber optic cable that includes both optical fibers for high-quality video transmission and copper conductors for power delivery, such as the Canare FCFA series. In another alternative embodiment, a micro-coaxial cable like the Samtec UMCX series could be used, which offers high-frequency signal transmission capabilities alongside power conductors in a small form factor.

The Rear Helmet Enclosure 200, positioned on the rear aspect of the helmet, in an embodiment comprises a battery pack that serves as the primary power source for both the receiver 250 contained within the Rear Helmet Enclosure 200 and the Display 320 located in the Front Helmet Enclosure 300. This battery pack utilizes CR123 disposable batteries, providing a voltage range of 4V to 6V. The power management system within the Rear Helmet Enclosure 200 employs DC-DC converters to efficiently distribute the appropriate voltage levels to various components.

The preferred embodiment of the invention incorporates a power supply system designed to meet the specific requirements of the weapon-mounted camera system. This system utilizes CR123 disposable batteries as the primary power source for both the Frontal Enclosure 100 and the Rear Helmet Enclosure 200. These batteries are selected for their compact size and high energy density, making them ideal for the portable nature of the camera system.

In the context of the preferred embodiment, the Frontal Enclosure 100 and the Rear Helmet Enclosure 200 each utilize two CR123 batteries connected in series. This configuration provides an input voltage range of 4V to 6V, which is crucial for powering the various components within each enclosure. The system is designed to operate effectively throughout this voltage range, ensuring consistent performance as the batteries discharge over time.

To manage the power requirements of different components, the system employs DC-DC converters, specifically boost and buck converters. In the Frontal Enclosure 100, which houses the Camera 260 and other components, a boost converter is employed to increase the battery voltage to 8V. This higher voltage is necessary to power the camera and the wireless transmitter effectively.

The Rear Helmet Enclosure 200, which contains the Display 320 and associated electronics, utilizes a boost converter to provide 12V for its components. Additionally, a buck converter is incorporated to step down the voltage to 5V, which is necessary for powering certain components like the wireless receiver 250 incorporated within the Rear Helmet Enclosure 200.

The use of these DC-DC converters offers several advantages for the system. Firstly, they allow for efficient use of the battery power, extending the operational time of both the Frontal Enclosure 100 and the Rear Helmet Enclosure 200=. Secondly, they provide voltage regulation, ensuring that each component receives its optimal operating voltage regardless of the battery's charge state. This is particularly important for sensitive electronics like the Camera 260 and Display 320, which require stable power for consistent performance.

The power management system also takes into account the operational temperature range of 0° C. to 50° C., ensuring that the DC-DC converters function effectively within these environmental conditions. This is crucial for maintaining system reliability in various combat or high-stress situations where the invention is intended to be used.

Based on the typical capacity of the CR123 batteries and the expected power consumption of the system components, the estimated battery life for the Frontal Enclosure 100 is approximately 7.5 hours, assuming a current draw of 200 mA. For the Rear Helmet Enclosure 200 (and the cable-linked Front Helmet Enclosure 300), the estimated runtime is about 4.5 hours, based on an assumed current draw of 330 mA.

This power supply design is critical for ensuring the proper functioning and longevity of the system in field conditions. It supports the core functionality of capturing and transmitting images from the Camera 260 to the Display 320 in real-time, even in challenging operational environments.

The AKK RC832 receiver 250 in the Rear Helmet Enclosure 200 in an embodiment, which operates on a 12V power supply, is powered by a boost converter within the Rear Helmet Enclosure 200 in an embodiment that steps up the battery voltage to the required level. Similarly, power is transmitted through the connecting cable to the Front Helmet Enclosure 300, where it is regulated to supply the 3.5-5V needed for the 0.39 Inch Viewfinder Display Module (Display 320).

This integrated power and signal transmission system ensures that the Display 320 in the Front Helmet Enclosure 300 receives both the necessary power and the video feed from the receiver 250 in a single, streamlined connection. This design not only enhances the system's reliability but also contributes to its compact and user-friendly nature, allowing for ease of use in high-stress combat situations.

The Display 320 in the Front Helmet Enclosure 300 comprises a 0.39 Inch Viewfinder Display Module specifically designed for AR glasses, thermal imaging, and night vision applications in accordance with an embodiment. This display offers a high resolution of 1024×768 pixels, surpassing the PAL video resolution requirement. It operates on a voltage range of 3.5-5V, which is supplied by the buck converter located either in the Rear Helmet Enclosure 200 or the Front Helmet Enclosure 300. The compact size of this display allows for integration into the helmet-mounted system without obstructing the user's normal field of view.

To enhance the wireless communication capabilities, the system in an embodiment incorporates at least one Readytosky Mini 5.8 G FPV Antenna with a 2.8 dBi gain and RHCP (Right Hand Circular Polarization) configuration. This antenna design provides a balance between signal strength and physical durability, which is crucial for the rugged environment in which the system in an embodiment is intended to operate.

The selection of these specific components ensures that the invention in an embodiment meets the required specifications for image quality, wireless transmission, power efficiency, and compact design. The Camera 260 provides high-resolution imagery, the wireless transmission system allows for real-time video feed, and the Display 320 presents clear images to the user, all within the compact and rugged design of the Frontal Enclosure 100, Rear Helmet Enclosure 200, and Front Helmet Enclosure 300. This combination of components enables the system to function effectively in various combat scenarios, providing users with enhanced situational awareness and the ability to view around corners or obstacles without exposing themselves to potential threats.

The preferred embodiment comprises a Rear Helmet Enclosure 200 as described herein. In the preferred embodiment of the invention, the Rear Helmet Enclosure 200 comprises a communications module to facilitate the transmission of the images or video captured by the Camera 260 of the Frontal Enclosure 100 to the Display 320 of the Front Helmet Enclosure 300. The present inventor has recognized that the placement of the Rear Helmet Enclosure 200 upon the rear aspect of the helmet facilitates the uninterrupted transmission of a wireless signal, or a latency-free signal, from aspects of the Frontal Enclosure to aspects of the Rear Helmet Enclosure 200 when configured as described herein.

The preferred embodiment of the invention comprises CR123 disposable batteries as the power source for either or both of the Frontal Enclosure 100 and the Rear Helmet Enclosure. These batteries are selected for their compact size and high energy density, making them ideal for the portable nature of the camera system. The CR123 batteries used in the system have a nominal voltage of 3.0 volts and a typical capacity of 1500 mAh when discharged to 2.0 volts. They can operate effectively within a temperature range of −40° C. to 60° C., which aligns with the assumed operating range of 0° C. to 50° C. for the proof of concept prototype.

In the context of the preferred embodiment, the Frontal Enclosure 100 and the Rear Helmet Enclosure 200, which in an embodiment is connected by wire and provides power to the Front Helmet Enclosure 300, each utilize two CR123 batteries connected in series. This configuration provides an input voltage range of 4V to 6V, which is crucial for powering the various components within each enclosure. The system is designed to operate effectively throughout this voltage range, ensuring consistent performance as the batteries discharge over time.

For the Frontal Enclosure 100, which houses the Camera 260 and other components, a boost converter is employed in an embodiment to increase the battery voltage to 8V. This higher voltage is necessary to power the camera and the wireless transmitter effectively. The Front Helmet Enclosure 300, which contains the Display 320 and associated electronics, utilizes a boost converter to provide 12V for its components. This voltage management in an embodiment ensures that all elements of the system receive the appropriate power levels for optimal operation.

The use of CR123 batteries in this configuration allows for an estimated battery life of approximately 7.5 hours for the Frontal Enclosure 100, assuming a current draw of 200 mA. For the aspects of the Rear Helmet Enclosure 200 and the wire-connected Front Helmet Enclosure 300, the estimated runtime is about 4.5 hours, based on an assumed current draw of 330 mA. These runtime estimates in accordance with an embodiment are derived from the typical capacity of the CR123 batteries and the expected power consumption of the system components, including the Camera 260, wireless transmitter in the Frontal Enclosure 100, and the Display 320 of the Front Helmet Enclosure 300 and wireless receiver 250 of the Rear Helmet Enclosure 200.

Furthermore, the power management system of the preferred embodiment, including the boost converters, is designed to work in conjunction with other critical components of the system. In an exemplary embodiment, it ensures that the Camera 260 in the Frontal Enclosure 100 receives stable power for consistent image capture, while also powering the wireless transmitter for real-time video transmission. In the Helmet Enclosure 300, the power system in an embodiment supports the Display 320, enabling clear viewing of the transmitted images at a range of less than 2″ from the user's eye, as well as powering the wireless receiver 250 for uninterrupted signal reception.

This power solution, in an embodiment deriving from the CR123 batteries, integrates with the overall design of the weapon-mounted camera system, supporting its core functionality of capturing and transmitting images from the Camera 260 to the Display 320 in real-time, even in challenging operational environments.

The power management system of an embodiment of the invention incorporates DC-DC boost converters and buck converters to efficiently manage the voltage requirements of various components within the Frontal Enclosure 100, Rear Helmet Enclosure 200 and Front Helmet Enclosure 300. This power supply design in an embodiment is critical for ensuring the proper functioning and longevity of the system in field conditions.

In the Frontal Enclosure 100, a DC-DC boost converter is employed to step up the voltage from the two series-connected CR123 batteries (4V to 6V range) to a consistent 8V output in accordance with an embodiment. This higher voltage is necessary to power the Camera 260 and the wireless transmitter effectively. The boost converter ensures that these components receive a stable power supply even as the battery voltage decreases over time, maintaining consistent performance throughout the operational period.

For the Rear Helmet Enclosure 200 and Front Helmet Enclosure 300, a similar DC-DC boost converter is utilized to increase the battery voltage to 12V in an embodiment. This higher voltage is required to power the Display 320 and other associated electronics within the helmet-mounted unit. Additionally, a buck converter is incorporated in either the Front Helment Enclosure or Rear Helmet Enclosure 200 in an embodiment to step down the 12V to 5V, which is necessary for powering certain components like the wireless receiver 250 of the Rear Helmet Enclosure 200.

The use of these DC-DC converters offers several advantages for the system in accordance with an embodiment of the invention. Firstly, they allow for efficient use of the battery power, extending the operational time of both the Frontal Enclosure 100 and the components of the Front Helmet Enclosure 300. Secondly, they provide voltage regulation, ensuring that each component receives its optimal operating voltage regardless of the battery's charge state. This is particularly important for sensitive electronics like the Camera 260 and Display 320, which require stable power for consistent performance.

Moreover, the power supply design in an embodiment accommodates the varying power requirements of different components. For instance, the wireless transmitter in the Frontal Enclosure 100, which operates at 25 mW, requires a specific voltage for optimal transmission power and range. The boost converter ensures that this voltage is consistently supplied, maintaining reliable wireless communication between aspects of the Frontal Enclosure 100 and the Rear Helmet Enclosure 200.

The power supply system in an embodiment of the invention also takes into account the operational temperature range of 0° C. to 50° C., ensuring that the DC-DC converters function effectively within these environmental conditions. This is crucial for maintaining system reliability in various combat or high-stress situations where an embodiment of the invention is intended to be used. The preferred embodiment of the invention is designed with the intent to achieve a balance between power efficiency, component performance, and system reliability. The use of DC-DC boost and buck converters allows for the optimal utilization of the CR123 batteries, ensuring that all components of the weapon-mounted camera system receive the appropriate power levels for sustained operation in the field in accordance with the preferred embodiment.

Various embodiments of the invention comprise a Front Helmet Enclosure 300 as described herein. The Front Helmet Enclosure 300 in the preferred embodiment comprises a Display 320. The Front Helmet Enclosure 300 is intended to affix to a Helmet 500 in such a way that its wearer can position the Display 320 in front of the eye for viewing. In various embodiments, the Display 320 is configured to display images and/or video captured from the Camera 260. The Display 320, in association with other aspects of the preferred embodiment of the system, is configured to display the images and/or video as captured by the Camera 260 in real time. In an embodiment, the Display 320 is further configured to display data obtained via the Rangefinder Laser. In various embodiments, the Front Helmet Enclosure 300 and Rear Helmet Enclosure 200 each further comprise a Helmet Attachment Means 340. In various embodiments, the Front Helmet Enclosure 300 is adjustable around a rotating joint 360. In various embodiments, the Display 320 is configured to present a reticle. In an embodiment, the Display 320 is configured to present an auto-adjusting reticle. It is contemplated by the inventor for the reticle and related aspects to be adjustably presented with relevant information by systems known in the art, such as those described in U.S. patent applications Ser. No. 11/732,573 published on May 17, 2012 and Ser. No. 13/135,158 published on Jun. 26, 2012; and U.S. Pat. No. 9,310,163 granted on Apr. 12, 2016, each of which is incorporated in its entirety by reference herein.

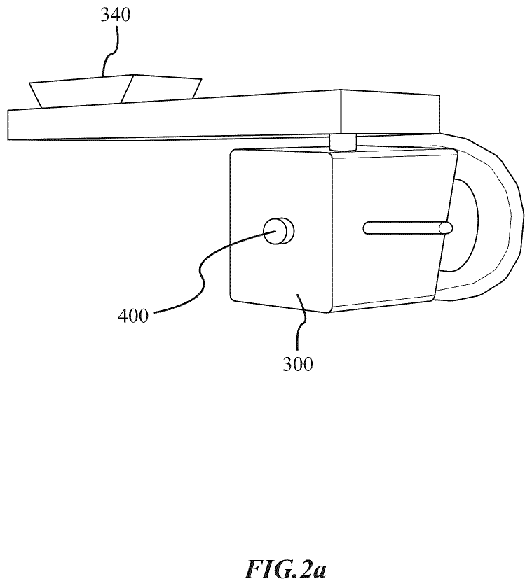

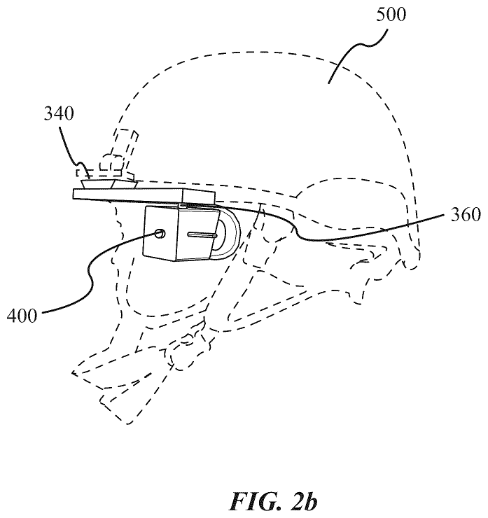

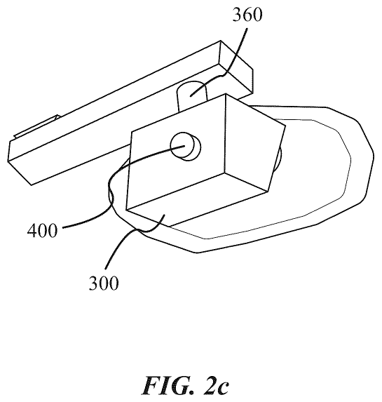

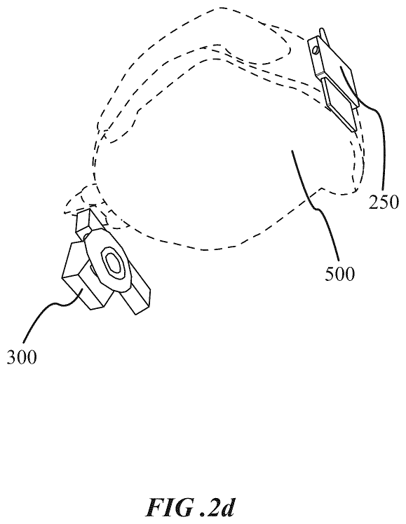

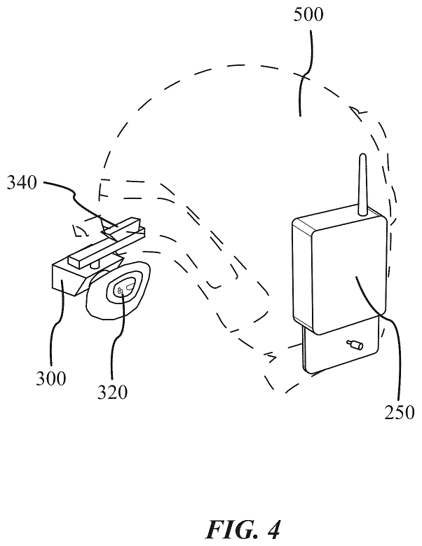

In the preferred embodiment, the Helmet Attachment Means 340 consists of a dovetail mount and fastening screws affixed to the exterior aspect of the Front Helmet Enclosure 300, as depicted by FIGS. 2a, 2b, and 4b. The present inventor anticipates the utilization of image processing circuitry coupled to the Display 320 and the Camera 260. In various embodiments, the Camera 260 incorporates multiple zoom levels and means to reduce the jitter associated with the capture of images, particularly at long distances. Embodiments of the invention may comprise mechanisms to accomplish jitter minimization and other relevant aspects such as those described within U.S. Pat. No. 9,036,035 issued on May 19, 2015, which is incorporated by reference in its entirety.

In various embodiments, the Front Helmet Enclosure 300 comprises one or more Adjustment Dials 290. The Adjustment Dial 290 in various embodiments is configured to change the zoom level depicted on the Display 320. In various embodiments, an Adjustment Dial 290 triggers a change in the information displayed upon the Display 320. In an embodiment an Adjustment Dial 290 changes the brightness of the Display 320. In various embodiments, the Adjustment Dial 290 may be rotated or pressed as a button to trigger different actions or changes to items displayed upon the Display 320.

An embodiment of the invention comprises a method for capturing and displaying images from a weapon-mounted camera system. This method begins with capturing images along the firing trajectory of a weapon using the Camera 260 housed within the Frontal Enclosure 100, which is attached to the frontal aspect of the weapon. The Camera 260, with its high resolution of at least 1000 lines and wide field of view of at least 90 degrees, ensures clear and detailed image capture in various combat scenarios.

Once captured, these images are wirelessly transmitted from the Frontal Enclosure 100 using the AKK X2-Ultimate 5.8 GHz transmitter. This transmitter operates on the 5.8 GHz frequency band and features adjustable power output levels ranging from 0.01 mW to 1000 mW, allowing for flexible operation in different combat scenarios while maintaining a stable video link.

The transmitted images are then received by the AKK RC832 receiver 250 located in the Rear Helmet Enclosure 200, which is attached to the rear aspect of the helmet. This receiver 250 is specifically designed to work in conjunction with the AKK X2-Ultimate transmitter, ensuring optimal performance and compatibility.

Following reception, the images and power are transmitted through a specialized cable from the Rear Helmet Enclosure 200 to the Front Helmet Enclosure 300, which is attached to the front aspect of the helmet. This cable efficiently transmits both power and video signals, interfacing with the video/power ports on both enclosures to ensure a streamlined and reliable connection.

Finally, the images are displayed on the Display 320 in the Front Helmet Enclosure 300. This display, a 0.39 Inch Viewfinder Display Module with a high resolution of 1024×768 pixels, exceeds PAL video resolution requirements and provides clear viewing of the transmitted images at a range of less than 2 inches from the user's eye.

The method also incorporates power management techniques to ensure efficient operation of the system. In the Frontal Enclosure 100, a DC-DC boost converter increases the voltage from two series-connected CR123 batteries (4V to 6V range) to a consistent 8V output. This higher voltage is necessary to power both the Camera 260 and the wireless transmitter effectively. Similarly, in the Rear Helmet Enclosure 200, another DC-DC boost converter increases the battery voltage to 12V for powering the receiver 250 and other components.

The wireless transmission and reception occur on the 5.8 GHz frequency band, with the transmitter's adjustable power output levels allowing for optimal performance in various operational environments. This flexibility is crucial for maintaining a stable video link in different combat scenarios.

Importantly, the method includes positioning the Frontal Enclosure 100 on the weapon in a way that does not obstruct the field of view of existing optical sights. The enclosure's low-profile design, measuring approximately 2 inches in length, 1.5 inches in width, and 0.75 inches in height, allows it to be mounted beneath most standard ACOG or reflex sights without interference. The top surface of the Frontal Enclosure 100 is contoured to follow the curvature of the Picatinny rail, sitting no more than 0.5 inches above the rail surface at its highest point. This design ensures that the soldier's line of sight through the primary optical sight remains unobstructed while still benefiting from the added capabilities of the weapon-mounted camera system.

Embodiments of the invention provides superior interchangeability and versatility compared to prior art systems. While prior art systems are designed to work exclusively with other sights of its kind, limiting compatibility with various weapon configurations, the present inventor has recognized that the preferred embodiment features a low-profile Frontal Enclosure 100 that can be easily integrated with existing weapon configurations. This design allows soldiers to maintain their preferred optical sights while gaining the additional benefits of a weapon-mounted camera system, enhancing situational awareness and operational effectiveness without compromising the functionality of their primary aiming devices.

The preferred embodiment of the Frontal Enclosure 100 is designed with specific dimensions and features to ensure compatibility with existing optical sights while maintaining a low profile. The enclosure measures approximately 2 inches in length, 1.5 inches in width, and 0.75 inches in height, allowing it to be mounted beneath most standard ACOG or reflex sight sightlines without obstructing their field of view. The lower profile design of the present invention is another significant advantage. Prior art systems often obstruct the weapon's existing scope picture, interfering with the user's ability to use previously installed gunsights such as ACOG, EOTech, or other reflex sights. In contrast, the present invention's Frontal Enclosure 100 is designed to be non-obstructive, allowing it to complement rather than replace existing optical systems. This approach preserves the functionality of the weapon's primary sights while adding the benefits of a camera system.

The top surface of the Frontal Enclosure 100 in an embodiment is contoured to follow the curvature of the Picatinny rail, sitting no more than 0.5 inches above the rail surface at its highest point. This low-profile design ensures that the soldier's line of sight through the primary optical sight remains unobstructed. The Camera 260 in an embodiment is positioned at the front of the enclosure, angled slightly downward at approximately 5 degrees to compensate for the height difference and maintain alignment with the weapon's bore axis. The Picatinny rail attachment mechanism is designed to be quick-release, allowing for easy installation and removal without tools, further enhancing the system's versatility and compatibility with various weapon configurations.

Furthermore, the preferred embodiment offers improved durability compared to systems using phosphorous tubes. Many night vision scopes rely on phosphorous tubes, which have a limited lifespan and require frequent replacement, leading to increased maintenance costs and potential downtime in critical situations. The preferred embodiment, by utilizing modern electronic components and a robust design, avoids these limitations. The use of non-phosphorous tube high-resolution digital cameras and displays, along with durable power management systems, ensures longer operational life and reduced maintenance requirements in accordance with the preferred embodiment.

The wireless transmission system employed in the preferred embodiment also contributes to its advantages over prior art. By utilizing a 5.8 GHz wireless transmission system with adjustable power output levels, the invention allows for flexible operation in various combat scenarios while maintaining a stable video link. This wireless capability, combined with the strategic placement of components on the weapon and helmet, minimizes the risk of signal interference or disconnection during use.

Additionally, the modular design of the preferred embodiment, with separate Frontal Enclosure 100 and Helmet Enclosure 300 components, offers greater flexibility and ease of use compared to more integrated systems. This modularity allows for easier maintenance, upgrades, and customization to suit different operational requirements.

In summary, the preferred embodiment addresses key limitations of prior art systems by offering enhanced interchangeability, a lower profile design, improved durability, advanced wireless capabilities, and a modular structure. These features collectively provide a more versatile, reliable, and user-friendly weapon-mounted camera system for modern combat situations.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

1. A system for capturing and displaying images from a weapon-mounted camera, comprising:
a frontal enclosure attachable to a frontal aspect of a weapon, the frontal enclosure comprising:
a camera configured to capture images along a firing trajectory of the weapon;
a wireless transmitter configured to transmit the captured images;
a first power supply module;
a rear helmet enclosure attachable to a rear aspect of a helmet, the rear helmet enclosure comprising:
a wireless receiver configured to receive the transmitted images;
a second power supply module;
a front helmet enclosure attachable to a front aspect of the helmet, the front helmet enclosure comprising:
a display configured to present the transmitted images; and
a cable connecting the rear helmet enclosure to the front helmet enclosure, the cable configured to transfer power and transmitted images between the rear and front helmet enclosures.

2-12. (canceled)

13. A method for capturing and displaying images from a weapon-mounted camera, comprising:
providing a first power supply comprising one battery or a plurality of batteries connected in series in a frontal enclosure;
increasing voltage from the first power supply using a first DC-DC boost converter in the frontal enclosure;
capturing images along a firing trajectory of a weapon using a camera powered by the increased voltage in the frontal enclosure attached to a frontal aspect of the weapon;
wirelessly transmitting the captured images from the frontal enclosure;
providing a second power supply comprising one battery or a plurality of batteries connected in series in a rear helmet enclosure;
increasing voltage from the second power supply using a second DC-DC boost converter in the rear helmet enclosure;
receiving the transmitted images at the rear helmet enclosure attached to a rear aspect of a helmet;
stepping down the voltage using a DC-DC buck converter in a front helmet enclosure;
transmitting the received images and power through a cable from the rear helmet enclosure to the front helmet enclosure attached to a front aspect of the helmet; and
displaying the images on a display powered by the stepped down voltage in the front helmet enclosure.

14-17. (canceled)

18. A weapon-mounted imaging system comprising:
a weapon-mountable enclosure comprising:
an image sensor;
a first power source; and
a first voltage converter configured to increase voltage from the first power source to a first predetermined level;
a wearable display unit comprising:
a display device;
a second power source;
a second voltage converter configured to increase voltage from the second power source to a second predetermined level; and
a third voltage converter configured to decrease the second predetermined level to a third predetermined level for powering the display device.

19. The system of claim 18, wherein:
the first voltage converter comprises a DC-DC boost converter;
the second voltage converter comprises a DC-DC boost converter; and
the third voltage converter comprises a DC-DC buck converter.

20. The system of claim 1, further comprising a method of power management comprising:
providing first and second independent power sources in physically separate enclosures;
increasing voltage from the first power source using a first boost converter to power imaging components;
increasing voltage from the second power source using a second boost converter to a higher intermediate level;
decreasing the intermediate level using a buck converter to power display components; and
maintaining different voltage levels appropriate for different components while preserving power efficiency.

21. The system of claim 1, further comprising:
a first enclosure containing:
a first battery power source;
a first DC-DC converter configured to boost voltage to a first level optimized for imaging components;
a second enclosure containing:
a second battery power source;
a second DC-DC converter configured to boost voltage to a second level higher than the first level;
a third DC-DC converter configured to buck voltage from the second level to a third level optimized for display components.

22. The system of claim 1, wherein the frontal enclosure further comprises a Picatinny rail attachment mechanism for securing the frontal enclosure to a Picatinny rail system of the weapon.

23. The system of claim 1, wherein the camera has a resolution of at least 1000 lines and a field of view of at least 90 degrees.

24. The system of claim 1, wherein the display has a resolution that meets or exceeds PAL video resolution.

25. The system of claim 1, wherein the wireless transmitter and wireless receiver operate on a 5.8 GHz frequency band.

26. The system of claim 25, wherein the wireless transmitter has adjustable transmission power settings.

27. The system of claim 1, wherein the frontal enclosure has dimensions of approximately 2 inches in length, 1.5 inches in width, and 0.75 inches in height, allowing it to be mounted beneath optical gun sights without obstructing their field of view.

28. The system of claim 1, wherein the cable comprises a shielded multi-conductor cable that incorporates both power and coaxial video lines within a single jacket.

29. The system of claim 1, wherein the frontal enclosure further comprises a thermal camera configured to capture thermal images along the firing trajectory of the weapon.

30. The method of claim 13, further comprising:
capturing images along a firing trajectory of a weapon using a camera in a frontal enclosure attached to a frontal aspect of the weapon;
wirelessly transmitting the captured images from the frontal enclosure;
receiving the transmitted images at a rear helmet enclosure attached to a rear aspect of a helmet;
transmitting the received images through a cable from the rear helmet enclosure to a front helmet enclosure attached to a front aspect of the helmet; and
displaying the images on a display in the front helmet enclosure.

31. The method of claim 30, wherein the wireless transmission and reception occur on a 5.8 GHz frequency band with adjustable transmission power.

32. The method of claim 30, further comprising positioning the frontal enclosure on the weapon such that it does not obstruct the field of view of existing optical sights on the weapon.

33. The method of claim 30, further comprising:
capturing thermal images along the firing trajectory of the weapon using a thermal camera in the frontal enclosure;
wirelessly transmitting the captured thermal images from the frontal enclosure;
receiving the transmitted thermal images at the rear helmet enclosure;
transmitting the received thermal images through the cable from the rear helmet enclosure to the front helmet enclosure; and
displaying the thermal images on the display in the front helmet enclosure.
